(19) United States
(12) Patent Application Publication
(10) Pub. No.: US 2025/0094234 A1
(43) Pub. Date: Mar. 20, 2025

(54) METHOD AND SYSTEM FOR RESOURCE OPTIMIZATION TO PERFORM AN OPERATION

(71) Applicant: Oracle International Corporation, Redwood Shores, CA (US)

(72) Inventors: Ming Fang, Bellevue, WA (US); Yifeng Liu, Bellevue, WA (US); Simo Lin, Bellevue, WA (US); Wei Gao, Bellevue, WA (US)

(73) Assignee: Oracle International Corporation, Redwood Shores, CA (US)

(21) Appl. No.: 18/676,239

(22) Filed: May 28, 2024

Related U.S. Application Data
(60) Provisional application No. 63/583,169, filed on Sep. 15, 2023.
(60) Provisional application No. 63/583,167, filed on Sep. 15, 2023.

(51) Int. Cl. G06F 9/50

(52) U.S. Cl. CPC G06F 9/5044

(57) ABSTRACT

A system and computer-implemented method include accessing a request for allocating graphical processing unit (GPU) resources for performing an operation. The request includes metadata identifying a client identifier associated with a client, throughput, and a latency of the operation. A predicted resource limit for performing the operation is determined based on the metadata. A parameter of GPU resources is obtained. The parameter includes a status indicating whether a GPU resource is occupied for performing another operation. A GPU resource utilization value is determined for each node based on the status. The GPU resource utilization value indicates the amount of utilization of GPU resources of the corresponding node. The GPU resource utilization value of each node is compared with a pre-defined resource utilization threshold value. The GPU resources are re-scheduled based on the predicted resource limit. Further, a set of GPU resources from the re-scheduled GPU resources for performing the operation.

### CROSS-REFERENCE TO RELATED APPLICATIONS

This application claims the benefit of and the priority to U.S. Provisional Application No. 63/583,167, filed on Sep. 15, 2023, and U.S. Provisional Application No. 63/583,169, filed on Sep. 15, 2023. Each of these applications is hereby incorporated by reference in its entirety for all purposes.

### BACKGROUND

Graphical processing unit (GPU) resources are utilized to perform several operations, such as complex calculations, finetuning of data models, etc. The operations are scheduled to be performed using specific GPU resources. Generative Artificial Intelligence (AI) is based on one or more models and/or algorithms that are configured to generate new content, such as new text, images, music, or videos. Frequently, Generative AI (GenAI) models receive complex prompts (e.g., in a natural language format, an audio/video file, an image, etc.) and generate a complex output. Each input prompt and/or each output may be represented in a high-dimensional space that may include one or more dimensionalities representing time, individual pixels, frequencies, higher dimensional features, etc. Often times, prompt processing is complex, as it can be important to assess a given portion of the input query in view of another portion of the input query.

In the early stage of GenAI, organizations focused more on bringing up the service instead of resource utilization. There does not exist a solution for resource optimization. Therefore, the early version of the service used the default behavior that a new GPU node is used for a workload, resulting in GPU underutilization. Thus, there is a need to efficiently optimize GPU resources to perform the requested operation. Such solutions would be particularly advantageous in the GPU context, as (for example) GPUs are significantly more expensive than CPUs and there is much lower availability of GPUs in the market relative to CPUs.

### SUMMARY

In some embodiments, a computer-implemented method is provided that comprises: accessing a request for allocating graphical processing unit (GPU) resources for performing an operation, wherein the request includes metadata identifying a client identifier (ID) associated with a client, a throughput, and a latency of the operation; determining a predicted resource limit for performing the operation based on the metadata; obtaining at least one parameter of a plurality of GPU resources present in a plurality of nodes, wherein the at least one parameter comprises a status indicating whether a corresponding GPU resource is occupied for performing another operation; determining a GPU resource utilization value of each node of the plurality of nodes based on the status of each GPU resource, wherein the GPU resource utilization value indicates an amount of utilization of GPU resources of corresponding node; comparing the GPU resource utilization value of each node with a pre-defined resource utilization threshold value; in response to determining that the GPU resource utilization value is less than the pre-defined resource utilization threshold value, re-scheduling the plurality of GPU resources based on the predicted resource limit; and allocating a set of GPU resources from the plurality of re-scheduled GPU resources for performing the operation.

A method disclosed herein may further comprise: simulating the request on each node of the plurality of nodes; determining a percentage of resource utilization for each node based on the simulation of the request; identifying a node from the plurality of nodes having highest percentage of resource utilization; and allocating the set of GPU resources from the identified node to the client.

A method disclosed herein may further comprise: determining a type of the operation based on the request; and allocating the set of GPU resources from the plurality of GPU resources based on the type of the operation.

A method disclosed herein may further comprise: generating a dedicated AI cluster by patching the set of GPU resources within a single cluster, wherein the dedicated AI cluster reserves a portion of a computation capacity of a computing system for a period of time; and allocating the dedicated AI cluster to the client associated with the client ID.

A method disclosed herein may further comprise: authenticating, prior to the allocation of the set of GPU resources, the request based on the client ID associated with the client, wherein the request is authenticated using a private key extracted from an asymmetric key pair associated with the client ID.

A method disclosed herein may further comprise: determining a number of tokens associated with the request; determining whether the number of tokens exceeds a pre-defined request limit corresponding to the client ID; and blocking the request based on the determination that the number of tokens exceeds the pre-defined request limit.

A method disclosed herein may further comprise: determinating patching of the set of GPU resources based on a pre-defined condition, wherein the pre-defined condition is one of: a failure of the set of GPU resources during launch; a workload failure of the set of GPU resources; and a software bug detected in the set of GPU resources.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a block diagram of a computing system for providing and supporting a generative Artificial Intelligence (AI) platform, according to an exemplary embodiment.

FIG. 2 illustrates an exemplary architecture of a data plane of the generative AI platform, according to an exemplary embodiment.

FIG. 3 illustrates a block diagram of the API server, according to an exemplary embodiment.

FIG. 4 illustrates a block diagram of the allocation module, according to an exemplary embodiment.

FIG. 5 illustrates a block diagram of the metering worker, according to an exemplary embodiment.

FIG. 6 illustrates a block diagram of the resource utilization calculation module, according to an exemplary embodiment.

FIG. 7 illustrates a block diagram of the resource optimization module, according to an exemplary embodiment.

FIG. 8 illustrates a flow chart for optimizing the GPU resources, according to an exemplary embodiment.

FIG. 9 depicts a simplified diagram of a distributed system for implementing certain aspects.

FIG. 10 is a simplified block diagram of one or more components of a system environment by which services provided by one or more components of an embodiment system may be offered as cloud services, in accordance with certain aspects.

FIG. 11 illustrates an example computer system that may be used to implement certain aspects.

### DETAILED DESCRIPTION

As described above, Generative AI models typically are very large and require immense computational resources for training and deployment. Optimization of GPU resources plays a vital role in performing operations, such as training and finetuning of the Generative AI models.

CPUs, while versatile and capable of handling various tasks, lack the parallel processing power that can efficiently train and deploy such large and sophisticated Generative AI models. In contrast, GPUs (Graphics Processing Units) excel at parallel computation. These hardware accelerators significantly speed up the training and inference processes, enabling faster experimentation, deployment, and real-time applications of generative AI across diverse domains. However, GPU usage presents several challenges. For example, utilization of GPUs is not optimized.

Certain aspects and features of the present disclosure relate to a technique for optimizing utilization of GPU resources. Routing of task requests is then performed in a manner such that the GPU resources are scheduled according to their current utilization. A request for allocating GPU resources to perform an operation is received. The request includes metadata that identifies a client identifier (ID) associated with a client, throughput, and a latency of the operation. Based on the metadata, a predicted resource limit is determined. The predicted resource limit signifies an amount of GPU resources required for performing the requested operation.

The GPU resources are managed by orchestrator tools (e.g., Kubernetes), which can provide load balancing via dynamic GPU allocation. An orchestrator tool may obtain parameters of the GPU resources present in the multiple nodes. The parameters include a status that indicates whether a corresponding GPU resource is occupied for performing another operation. The orchestrator tool further determines a GPU resource utilization value of each node of the multiple nodes based on the status of each GPU resource. The GPU resource utilization value indicates the amount of utilization of GPU resources of the corresponding node. The GPU resource utilization value of each node is compared with a pre-defined resource utilization threshold. In response to determining that the GPU resource utilization value is less than the pre-defined resource utilization threshold value, the orchestrator tool re-schedules the GPU resources based on the predicted resource limit. In order to bin-pack GPU workloads, the service periodically re-schedules pods to improve GPU resource utilization in the cluster. Service has an internal scheduler simulator which will help it predict where pods will be placed if they are moved. Before making request re-scheduling decisions, the service uses an orchestrator-tool scheduler simulator to determine where pods would be placed based on the current cluster state. The orchestrator-tool scheduler simulator may simulate the behavior of a scheduler of the default orchestrator tool. In an example, for each GPU node in the cluster, the orchestrator tool checks if the node's GPU resource utilization is below the pre-defined resource utilization threshold. If it does, then GPU resource utilization can be optimized through the below-mentioned process.

Firstly, the orchestrator tool obtains all candidate pods including GPU resource for re-scheduling on the GPU node. Candidate pods are any pods running on GPU nodes unless they are specifically excluded through the—skip-pods-with-labels or—skip-system-pods flags. Further, the orchestrator tool runs the scheduling simulator for the candidate pod. If the percentage of GPU resources used by the node will improve by moving the candidate pod to the suggested node, then the process proceeds to the next step.

In an example where eviction would occur, a pod which requires 1 GPU card is currently running on node A which is using 1 out of 8 GPU cards. The scheduling simulator predicts the pod will get moved to node B which is currently using 7 out of 8 GPU cards. Service would evict the pod so the pod moves to node B because the GPU cards would be utilized more optimally (7+1)/8>1/8.

In an example where eviction would not occur, a pod which requires 1 GPU card is currently running on node A which is using 8 out of 8 GPU cards. The scheduling simulator predicts the pod will get moved to node B which is currently using 4 out of 8 GPU cards. Service would not evict the pod because the GPU cards are currently used more optimally on node A 8/8>(4+1)/8.

In an embodiment, the orchestrator tool determines a type of operation based on the request and allocates a set of GPUs from the multiple GPUs based on the type of the operation. Further, the orchestrator tool generates a dedicated AI cluster by patching the set of GPU resources within a single cluster. The dedicated AI cluster reserves a portion of computation capacity of a computing system for a period of time. The dedicated AI cluster is allocated to the client associated with the client ID.

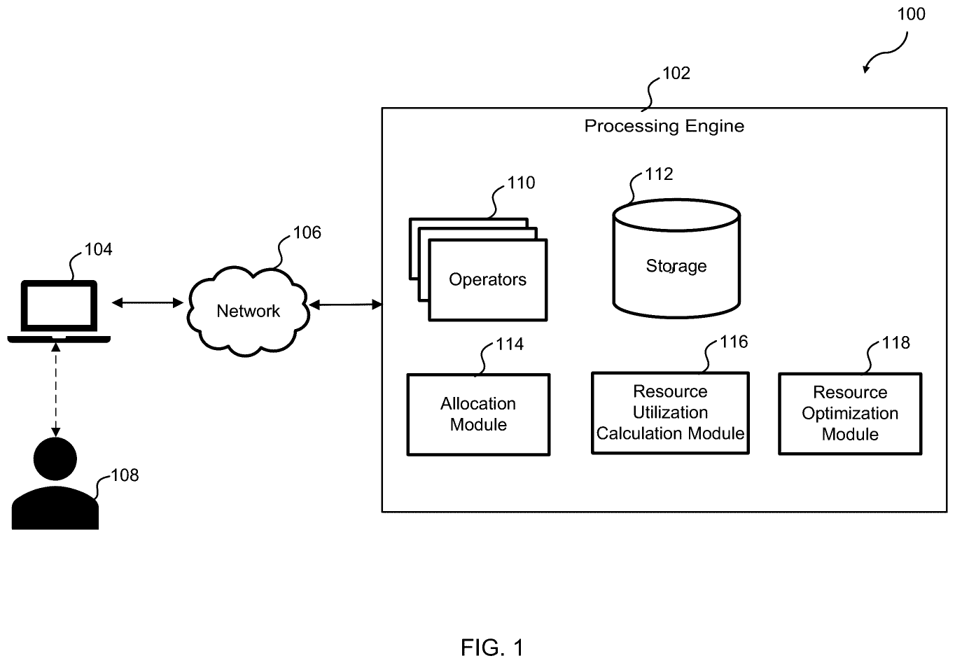

FIG. 1 illustrates a block diagram of a computing system 100 for providing and supporting a generative Artificial Intelligence (AI) platform 102, according to an exemplary embodiment. The computing system 100 supports the provision of a generative AI in response to a request received from a client. The generative AI platform 102 is communicatively coupled to a client system 104 through a network 106. It is noted that a single-client system 104 (e.g., shown as client system 104) is for illustration, and the scope of the present disclosure is not limited to it. The computing system 100 may host several client systems 104 sequentially, alternatively, or parallelly. Each client system 104 is associated with a corresponding client 108.

The network 106 may include suitable logic, circuitry, and interfaces configured to provide several network ports and several communication channels for transmission and reception of data and/or instructions related to operations of the generative AI platform 102 and the client system 104. The network 106 could include a Wireless Area Network (WAN), a Local Area Network (LAN), and/or the Internet for various embodiments. Some computing systems 100 could have multiple hardware stations throughout the warehouse or factory lines connected by the network 106. There could be distributed plants at different locations tied together by network 106.

The client system 104 may include various types of computing systems such as Personal Assistant (PA) devices, portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head-mounted displays and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. Client system 104 108 may be capable of executing various applications such as various Internet-related apps and communication applications (e.g., E-mail applications, short message service (SMS) applications) and may use various communication protocols.

The Generative AI platform 102 includes operators 110 that controls modules of the generative AI platform 102. Operators 110 manage whole life cycle of resources, such as dedicated AI cluster, fine tuning jobs, and/or serving models. The operators 110 utilize an orchestrator tool (e.g., Kubernetes) to perform various operations. In some embodiments, the operators 110 include a dedicated AI cluster (DAC) operator, a model operator, a model endpoint operator, and a Machine Learning (ML) jobs operator.

The DAC operator utilizes the orchestrator tool to reserve capacity in generative AI data plane. Generative AI is responsible for reserving a particular number of GPU resources for a client. The DAC operator manages the lifecycle of the DAC including capacity allocation, monitoring, and patching. The model operator handles the life cycle of a model, including both base model and fine-tuned model. the model endpoint operator manages the lifecycle of provisioning and hosting pre-trained or fine-tuned model (storage, access, encryption). The ML jobs operator provides services of the ML models that orchestrates execution of long-running processes or workflows.

The generative AI platform 102 further includes a storage 112 for temporarily or permanently storing data for performing various operations. For example, the storage 112 stores instructions executable by the operators for performing operations.

The generative AI platform 102 includes several modules for performing separate tasks. In some embodiments, the generative AI platform 102 may include an allocation module 114 for allocating/reserving GPU resources for a particular client in response to a request received from the client. The request is received from the client system 104 through network 106. The allocation module 114 is responsible for managing uptime and patching nodes to form the DAC. The DAC is some amount of computation capacity reserved for a single customer for an extended and/or predefined period of time (e.g., at least a month). The allocation module 114 may then provide and maintain the computation capacity for the client, who requires predictable performance and throughput for their operation.

The generative AI platform 102 further includes a resource utilization calculation module 116 for calculating a GPU resource utilization value for each node. The GPU resource utilization value is calculated based on the status of each GPU resource. For example, if a GPU node has 8 GPU cards and 7 GPU cards are currently utilized. In such a case, the GPU resource utilization value is calculated to be 7/8.

The generative AI platform 102 further includes a resource optimization module 118 for optimizing the utilization of the GPU resources. The resource optimization module 118 obtains the GPU resource utilization value from the resource utilization calculation module 116 and reschedules the GPU resources based on the GPU resource utilization value. For example, if the GPU resource utilization value is less than the pre-defined resource utilization threshold value then the resource optimization module 118 instructs the allocation module 114 to allocate the GPU resources from another GPU node. Functions of the allocation module 114, the resource utilization calculation module 116, and the resource optimization module 118 are described in detail through subsequent paragraphs.

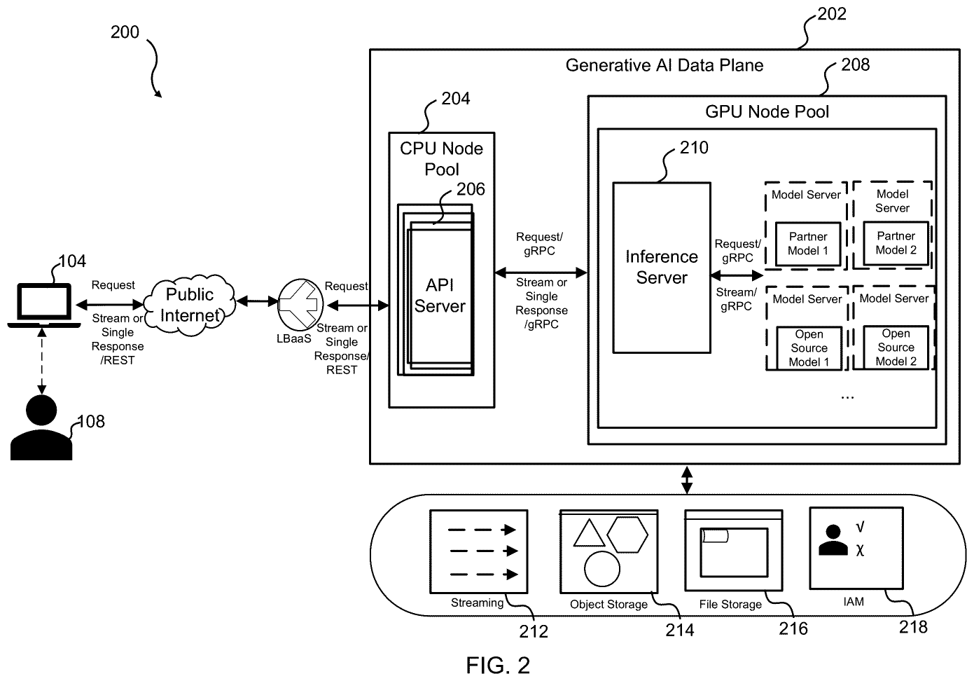

FIG. 2 illustrates an exemplary architecture 200 of a data plane of the generative AI platform 102, according to an exemplary embodiment. As illustrated in FIG. 2, a generative AI data plane 202 receives a service request from the client system 104 associated with the client 108. The service request may be and/or include a request for performing an operation. For example, the client 108 may host a website that is configured to receive input that requests particular information (e.g., via selecting one or more options or providing a text input). The service request may be defined to include the input or a transformed version thereof (e.g., that introduces some structure). The request may be transmitted through a network (e.g., the Internet) and/or a Load Balancer as a Service (LBaaS). The generative AI data plane 202 includes a CPU node pool 204 having multiple API servers 206. Each API server may receive a corresponding request and may forward the request to a GPU node pool 208. Each component of the API server 206 is described in further detail in successive paragraphs.

The GPU node pool 208 includes an inference server 210 for translating the service request to generate one or more prompts executable by one or more data models, such as a partner model or an open-source model. The generative AI data plane 202 may be connected to a streaming module 212, an object storage module 214, a file storage module 216, and/or an Identity and Access Management (IAM) module 218. Each module (including the streaming module 212, the object storage module 214, the file storage module 216, and the IAM module 218) may be configured to perform processing as configured. For example, the streaming module 212 may be configured to support metering and/or billing, the object storage module 214 may be configured to store instances of executable programs, the file storage module 216 may be configured to store ML models and other supporting applications, and the IAM module 218 may be configured to manage authentication and authorization of the client.

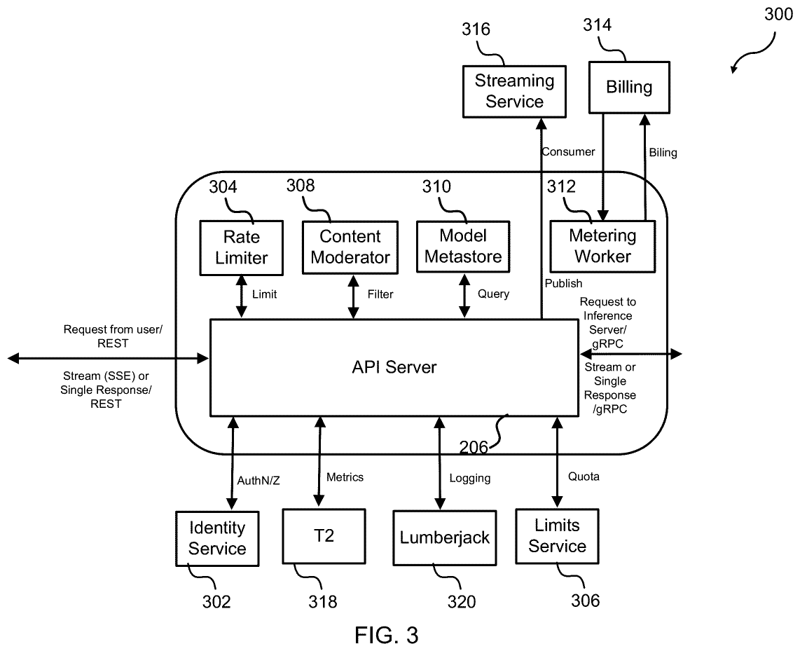

FIG. 3 illustrates a block diagram 300 of the API server 206, according to an exemplary embodiment. The API server 206 is capable of receiving and managing a service request from a client. The service request may be a request for generating text or fine-tuning of AI models. The API server 206 utilizes various components for processing the service request, embedding the service request to inferencing components and returning a response to the service request to the client.

The API server 206 integrates with an identity service module 302 for performing authentication of the service request. The identity service module 302 extracts client identifier (ID) from the service request and authenticates the service request based on the client ID. In some embodiments, the request is authenticated using a private key extracted from an asymmetric key pair associated with the client ID.

After authentication, the service request is provided to a rate limiter 304. The rate limiter 304 tracks the service request of each client 108 received from the client system 104. The rate limiter 304 integrates with a limits service 306 for obtaining pre-defined limits, such as a number of requests per minute (RPM) and a number of tokens that are allowed for each client system 104. The number of tokens (input/output) varies from request to request. For example, a service request can consume a pre-defined number of tokens, for example between 10 to 2048 tokens for small and medium LLMs, while larger and more powerful LLMs allow up to 4096 tokens.

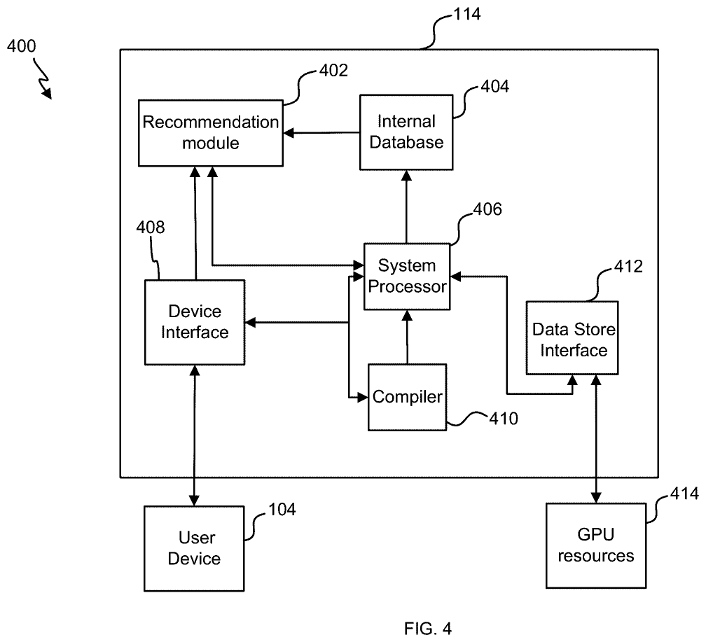

The rate limiter 304 extracts a number of input tokens and a number of tokens for output associated with the service request. The rate limiter 304 limits the rate of incoming service requests from the client system 104 using the pre-defined limits obtained from the limits service 306. The rate limiting may be performed as RPM-based rate limiting or a token-based rate limiting. The rate limiter 304 may allow a pre-defined quantity of tokens per minute per model for each client system 104. In yet another implementation, the limits may be imposed based on tenancy ID or client ID associated with the client system 104 as the key. Functions of the rate limiter 304 are explained in detail with respect to FIG. 4.

API server 206 further includes a content moderator 308 for filtering contents included in the service request by removing sensitive or toxic information from the service request. In an implementation, the content moderator 308 filters training data before training and fine tuning of LLM. In such a way, LLM response does not give responses about sensitive or toxic information, such as how to commit crimes or engage in unlawful activities, and monitoring model response by filtering or halting response generation if the result contains undesirable contents.

The API server 206 further includes a model metastore 310. The model metastore 310 may be a storage unit configured to store LLM-related metadata, such as LLM capabilities, display name, and creation time. The model metastore 310 can be implemented in two ways. The first implementation is an in-memory model metastore, where metadata is stored in an in-memory cache. The model metastore 310 is populated using resource file(s) that are code-reviewed and checked into a GenAI API repository. During deployment of the API server 206, the model-related metadata is loaded into the memory. Second implementation is using a persistent model metastore. The persistent model metastore enables custom model training or fine-tuning. In the persistent model metastore, data related to LLM models (both pretrained and custom-trained) are stored in a database. The API server 206 may query the model metastore 310 for LLM-related metadata. The model metastore 310 may provide the LLM-related metadata in response to the query.

The API server 206 further comprises a metering worker 312 for scheduling the service request received from the client system 104. The metering worker 312 is communicatively coupled to a billing server 314. The metering worker 312 processes the service request and communicates with the billing server 314 to generate a bill regarding each process performed for the service request. The API server 206 is communicatively connected with a streaming service 316 for providing a lightweight streaming solution to stream tokens back to the client system 104 whenever a token is generated.

The API server 206 is communicatively connected with a prometheus T2 unit 318. The prometheus T2 unit 318 is a monitoring and alerting system internally developed within the infrastructure. The prometheus T2 unit 318 enables the API server 206 to scrape metrics from various sources at regular intervals. By utilizing prometheus T2, the API server 206 gains the ability to collect a wide range of metrics, such as GPU utilization, latency, CPU utilization, LLM performance, etc. These metrics can then be used for creating alarms and visualizations in Grafana, providing valuable insights into performance of generative AI services associated with the LLM model, health of the LLM model, and resource utilization by the LLM model.

The generative AI services utilizes a logging architecture that combines Fluent Bit and Fluentd. Fluent Bit is deployed as a daemonset, running on each GPU resource, and will act as a log forwarder. It efficiently collects logs from various GPU resources within API server 206 and sends them to Fluentd. Fluentd, functioning as an aggregator, receives logs from Fluent Bit and performs further processing or filtering if needed. periodically flush the logs to Lumberjack 320, a log shipping protocol, at defined intervals. This architecture enables efficient log collection, aggregation, and transmission, ensuring comprehensive and reliable logging for the Generative AI services.

FIG. 4 illustrates a block diagram 400 of the allocation module 114, according to an exemplary embodiment. The allocation module 114 comprises a recommendation module 402, an internal database 404, a system processor 406, a device interface 408, a compiler 410, and a data store interface 412.

The internal database 404 is configured to store the user credentials at the time of registration of the user in the system application. System processors 406 may update stored user credentials in response to the user request or any unauthorized login which is not done by the user 108. The comparator is configured to compare user credentials received from the client system 104 with pre-stored user credentials stored in the internal database 404. If the received user credentials match with the pre-stored user credentials, then the user would be allowed to log in to the system application.

In one exemplary embodiment, the unauthorized login may refer to a login done on a device different from the client system 104. In that case, the system transmits a notification to the client system 104 to confirm that the login into another device is done by the user 108. The user credentials stored in the internal database 404 may be updated when user 108 confirms that the login is not done by user 108 in response to the notification.

System processor 406 is configured to control the overall function of the allocation module 114. The system processor 406 is communicatively coupled to other components like the comparator, the internal database 404, the device interface 408, the compiler 410, and the data store interface 412.

Further, the system processor 406 receives a comparison result from the comparator. The comparison result is analyzed by system processor 406 to determine whether user 108 should be provided access to login in the system application. Further, the system processor 406 activates the device interface 408 to receive the user data from the database.

In addition to that, system processor 406 activates the data store interface 412 to receive the resource information from GPU resources 414. In addition to that, the system processor 406 activates the device interface 408 to receive the user input or the user data from the client system 104. Components of the allocation module 114 like the device interface 408, and the data store interface 412 are activated by system processors 406 by the transmission of an activation signal from system processors 406 to the respective component. Additionally, system processor 406 receives a result from the compiler to determine user intent from the user input.

Device interface 408 is configured to receive the user input and the user data from the client system 104 and transmit to system processor 406 based on an activation signal received by the system processor 406.

The compiler 410 is configured to receive the user input from the device interface 408 in a natural language and convert the natural language into a machine level language which is executable by the system processor 406.

The data store interface 412 is configured to retrieve the resource information from the GPU resources 414 and transmit it to the system processor 406 based on an activation signal received by the system processor 406. The resource information includes a parameter that includes a status indicating whether a corresponding GPU resource is occupied for performing another operation.

The recommendation module 402 analyses the user query from the user interface to discern user intent through a natural language search (NLS) engine. The user intent is translated into actionable commands through the processing data associated with the events. Further, the recommendation module 402 determines GPU resources based on the user intent and the parameter of each GPU resource.

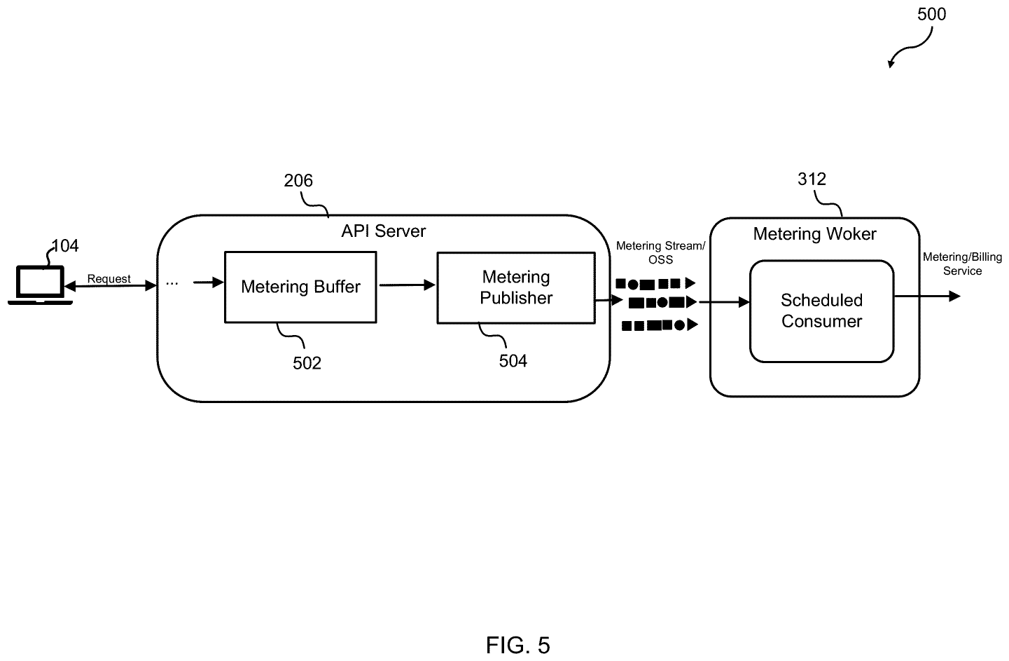

FIG. 5 illustrates a block diagram 500 of the metering worker 312, according to an exemplary embodiment. The API server 206 may include the metering buffer 502 for temporarily storing the service request received from the client system 104. The service request may be transferred to a metering publisher 504 sequentially. The metering publisher 504 may send the service requests to the metering worker 312 where each request is scheduled for processing. The billing server 314 may generate a bill regarding each process performed for the service request.

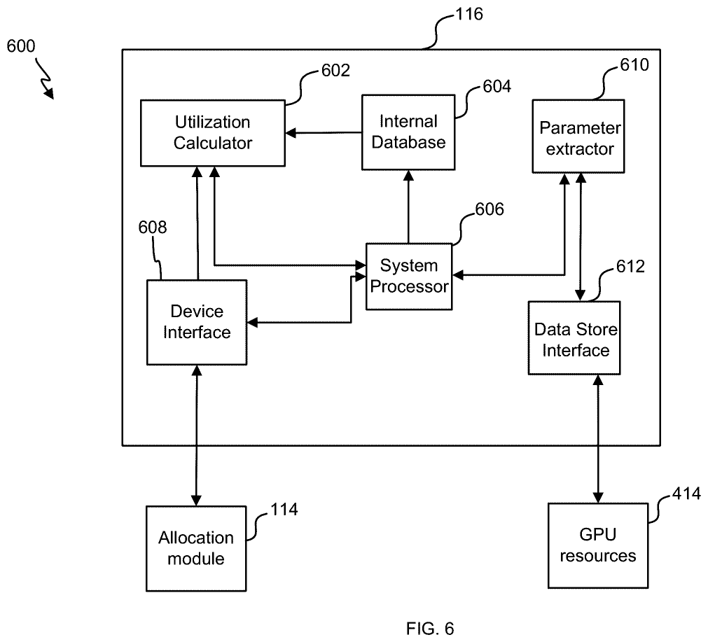

FIG. 6 illustrates a block diagram 600 of the resource utilization calculation module 116, according to an exemplary embodiment. The resource utilization calculation module 116 comprises a utilization calculator 602, an internal database 604, a system processor 606, a device interface 608, a parameter extractor 610, and a data store interface 612.

The utilization calculator 602 is configured to determine a GPU resource utilization value of each node based on the status of each GPU resource. The GPU resource utilization value indicates an amount of utilization of the GPU resources of the corresponding node. For example, if a GPU node has 8 GPU cards and 7 GPU cards are currently utilized. In such a case, the GPU resource utilization value is calculated to be 7/8.

The internal database 604 is configured to store information required for calculating the GPU resource utilization value. For example, the internal database 604 may store configuration of each GPU resource present in the GPU node. System processor 606 may update the information required for calculating the GPU resource utilization value. System processor 606 obtains parameters of each GPU resource and provides the parameters to the internal database 604.

The parameters may be fetched through the parameter extractor 610. The parameter extractor 610 is communicatively coupled with the GPU resources through the data store interface. The parameter extractor 610 may decode the information received from each GPU resource to extract the parameters of the GPU resources. Further, the parameter extractor 610 provides the decoded parameters to system processor 606.

System processor 606 is configured to control the overall function of resource utilization calculation module 116. The system processor 606 is communicatively coupled to other components like the utilization calculator 602, the internal database 604, the device interface 608, the parameter extractor 610, and the data store interface 612.

System processor 606 activates the data store interface 612 to receive the resource information from GPU resources 414. In addition to that, the system processor 606 activates device interface 608 to receive the information from the allocation module 114. Components of the resource utilization calculation module 116 like the device interface 608, and the data store interface 612 are activated by system processor 606 by the transmission of an activation signal from system processor 606 to the respective component.

The data store interface 612 is configured to retrieve the resource information from the GPU resources 414 and transmit it to the parameter extractor 610 based on an activation signal received by the system processor 606. The resource information includes a parameter that includes a status indicating whether a corresponding GPU resource is occupied for performing another operation.

The utilization calculator 602 is configured to determine a GPU resource utilization value of each node based on the status of each GPU resource. The GPU resource utilization value indicates an amount of utilization of the GPU resources of the corresponding node. For example, if a GPU node has 8 GPU cards and 7 GPU cards are currently utilized. In such a case, the GPU resource utilization value is calculated to be 7/8.

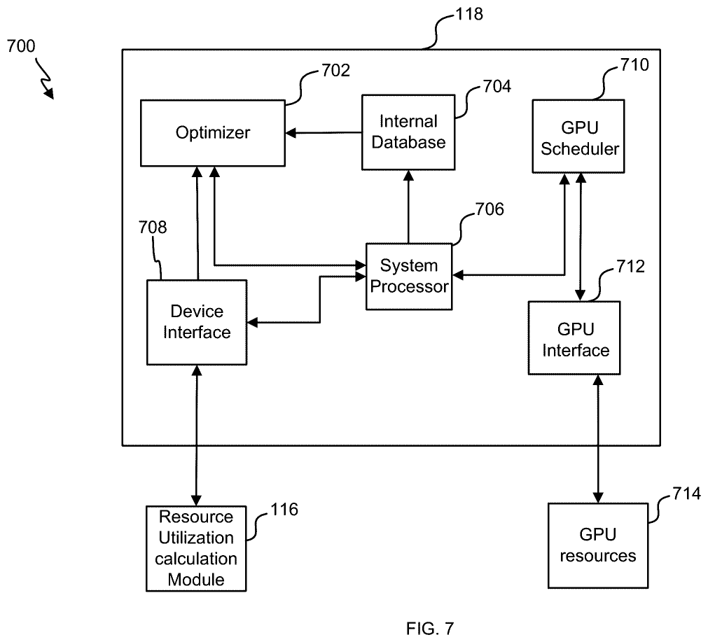

FIG. 7 illustrates a block diagram 700 of the resource optimization module 118, according to an exemplary embodiment. The resource optimization module 118 comprises an optimizer 702, an internal database 704, a system processor 706, a device interface 708, a GPU scheduler 710, and a GPU interface 712.

Optimizer 702 is configured to fetch the GPU resource utilization value from the resource utilization calculation module 116 and the information related to each GPU resource. Furthermore, optimizer 702 utilizes the GPU resource utilization value and the information related to each GPU resource to optimize the processing of the GPU resources.

The internal database 704 is configured to store information required for optimizing the GPU resources. For example, the internal database 704 may store configuration of each GPU resource present in the GPU node. System processor 706 may update the GPU resource utilization value in the internal database 704.

The GPU resource utilization value may be provided to GPU scheduler 710. The GPU scheduler 710 may communicate with each GPU resource through the GPU interface 712. The GPU scheduler schedules each GPU resource of the GPU node based on the GPU resource utilization value and the predicted resource limit. For example, if the GPU resource utilization value is less than the pre-defined resource utilization threshold value, the GPU scheduler 710 re-schedules the GPU resources based on the predicted resource limit. The GPU scheduler 710 allocates the GPU resources from the GPU nodes for performing the operation requested by the client.

System processor 706 is configured to control the overall function of the resource optimization module 118. The system processor 706 is communicatively coupled to other components like the optimizer 702, the internal database 704, the device interface 708, the GPU scheduler 710, and the GPU interface 712.

System processor 706 activates the GPU interface 712 to receive the resource information from GPU resources 414. In addition to that, the system processor 706 activates device interface 708 to receive the information from the resource optimization module 118. Components of the resource optimization module 118 like the device interface 708, and the GPU interface 712 are activated by system processor 706 by the transmission of an activation signal from system processor 706 to the respective component.

The GPU interface 712 is configured to provide scheduling information from the GPU scheduler 710 to the GPU resources 414. The GPU resources 414 may be scheduled based on the scheduling information received from the GPU interface 712.

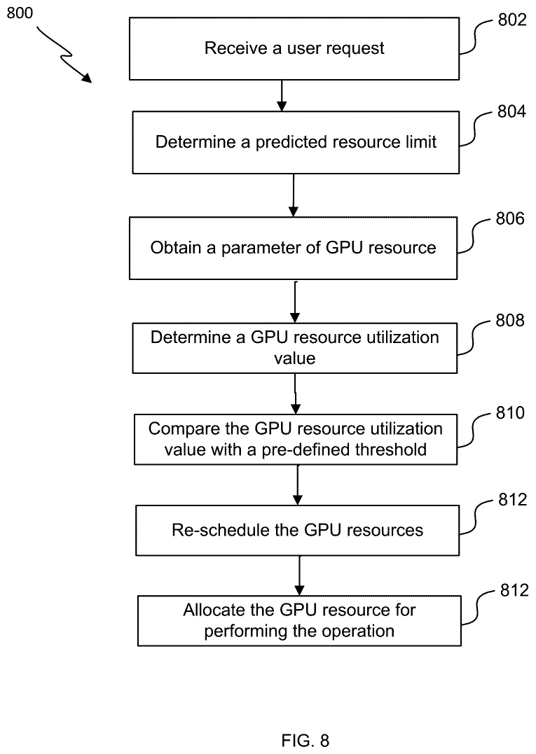

FIG. 8 illustrates a flowchart 800 for optimizing the GPU resources, according to an exemplary embodiment. The flowchart 800 explains an exemplary method to be executed by the computing system 100 for providing and supporting the generative AI platform 102.

At step 802, the computing system 100 receives a request for allocating GPU resources for performing an operation. The request includes metadata identifying a client ID associated with a client, throughput, and a latency of the operation. The client ID is the identity of the client. Further, the request is authenticated based on the client ID associated with the client. The request is authenticated using a private key extracted from an asymmetric key pair associated with the client ID.

At step 804, a predicted resource limit for performing the operation may be determined based on the metadata. For example, computing system 100 obtains metadata associated with the request and analyzes the throughput and the latency of the operation. Using this information, the computing system 100 determines the predicted resource limit for performing the operation.

At step 806, a parameter of each GPU resource is obtained by computing system 100. The parameter includes a status indicating whether a corresponding GPU resource is occupied for performing another operation. At step 808, a GPU resource utilization value of each node is calculated based on the status of each GPU resource. The GPU resource utilization value indicates the amount of utilization of GPU resources of the corresponding node.

At step 810, the GPU resource utilization value of each node is compared with a pre-defined resource utilization threshold value. The pre-defined resource utilization threshold value indicates a minimum value within which the utilization of GPU resources is optimized.

At step 812, the GPU resources are allocated based on the predicted resource limit. Such allocation is performed in response to the determination that the GPU resource utilization value is less than the pre-defined resource utilization threshold value. At step 814, the GPU resources are allocated from the rescheduled GPU resources. The allocated GPU resources are utilized to perform the operation requested by the client.

In one embodiment, the request may be simulated on each node of the multiple nodes. A percentage of resource utilization may be determined for each node based on the simulation of the request. Further, a node may be identified from the plurality of nodes having highest percentage of resource utilization. Furthermore, the set of GPU resources is allocated from the identified node to the client.

In one embodiment, a type of the operation may be determined based on the request. The set of GPU resources are determined from the GPU resources based on the type of the operation.

In one embodiment, a dedicated AI cluster is generated by patching the set of GPU resources within a single cluster. The dedicated AI cluster reserves a portion of a computation capacity of a computing system for a period of time. The dedicated AI cluster is allocated to the client associated with the client ID.

In one embodiment, a number of tokens associated with the request may be determined. Further, it may be determined whether the number of tokens exceeds a pre-defined request limit corresponding to the client ID. The request may be blocked based on the determination that the number of tokens exceeds the pre-defined request limit.

In one embodiment, patching of the set of GPU resources is terminated based on a pre-defined condition. The pre-defined condition may be a failure of the set of GPU resources during launch, a workload failure of the set of GPU resources, and a software bug detected in the set of GPU resources.

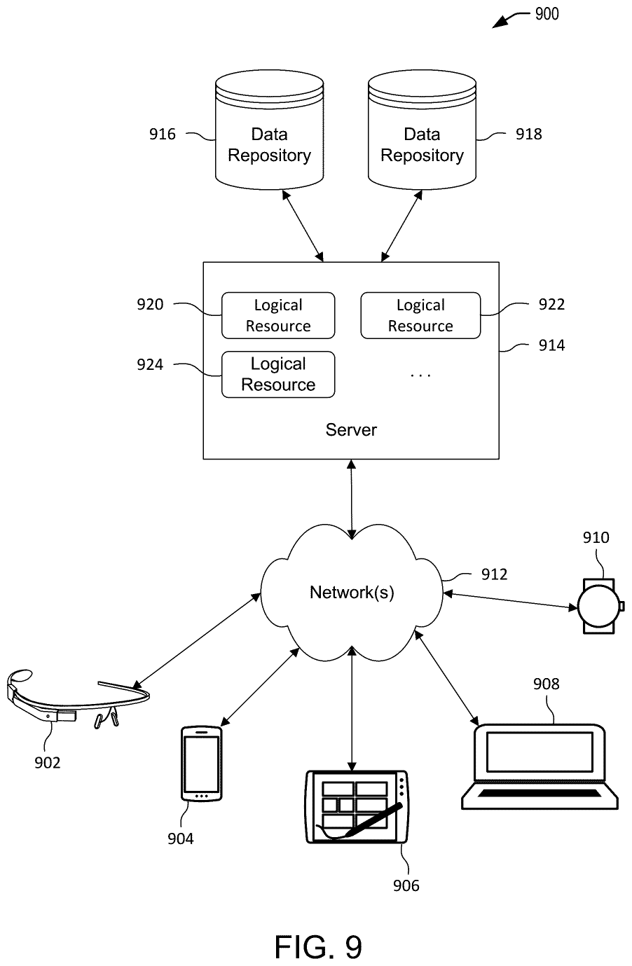

FIG. 9 depicts a simplified diagram of a distributed system 900 for implementing an embodiment. In the illustrated embodiment, distributed system 900 includes one or more client computing devices 902, 904, 906, 908, and/or 910 coupled to a server 914 via one or more communication networks 912. Clients computing devices 902, 904, 906, 908, and/or 910 may be configured to execute one or more applications.

In various aspects, server 914 may be adapted to run one or more services or software applications that enable one or more techniques disclosed herein.

In certain aspects, server 914 may also provide other services or software applications that can include non-virtual and virtual environments. In some aspects, these services may be offered as web-based or cloud services, such as under a Software as a Service (SaaS) model to the users of client computing devices 902, 904, 906, 908, and/or 910. Users operating client computing devices 902, 904, 906, 908, and/or 910 may in turn utilize one or more client applications to interact with server 914 to utilize the services provided by these components.

In the configuration depicted in FIG. 9, server 914 may include one or more components 920, 922 and 924 that implement the functions performed by server 914. These components may include software components that may be executed by one or more processors, hardware components, or combinations thereof. It should be appreciated that various different system configurations are possible, which may be different from distributed system 900. The embodiment shown in FIG. 9 is thus one example of a distributed system for implementing an embodiment system and is not intended to be limiting.

Users may use client computing devices 902, 904, 906, 908, and/or 910 for one or more techniques disclosed herein. A client device may provide an interface that enables a user of the client device to interact with the client device. The client device may also output information to the user via this interface. Although FIG. 9 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 912 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 912 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 914 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 914 can include one or more virtual machines running virtual operating systems, or other computing architectures involving virtualization such as one or more flexible pools of logical storage devices that can be virtualized to maintain virtual storage devices for the server. In various aspects, server 914 may be adapted to run one or more services or software applications that provide the functionality described in the foregoing disclosure.

The computing systems in server 914 may run one or more operating systems including any of those discussed above, as well as any commercially available server operating system. Server 914 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 914 may include one or more applications to analyze and consolidate data feeds and/or event updates received from users of client computing devices 902, 904, 906, 908, and/or 910. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 914 may also include one or more applications to display the data feeds and/or real-time events via one or more display devices of client computing devices 902, 904, 906, 908, and/or 910.

Distributed system 900 may also include one or more data repositories 916, 918. These data repositories may be used to store data and other information in certain aspects. For example, one or more of the data repositories 916, 918 may be used to store information for one or more techniques disclosed herein. Data repositories 916, 918 may reside in a variety of locations. For example, a data repository used by server 914 may be local to server 914 or may be remote from server 914 and in communication with server 914 via a network-based or dedicated connection. Data repositories 916, 918 may be of different types. In certain aspects, a data repository used by server 914 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 916, 918 may also be used by applications to store application data. The data repositories used by applications may be of different types such as, for example, a key-value store repository, an object store repository, or a general storage repository supported by a file system.

In one embodiment, server 914 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

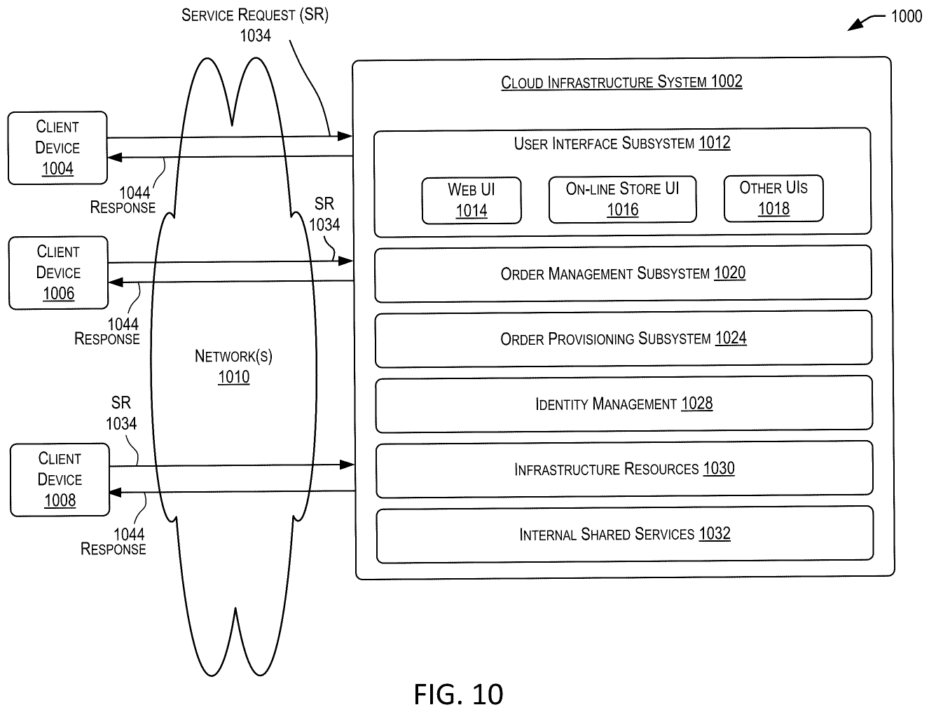

FIG. 10 is a simplified block diagram of a cloud-based system environment, in accordance with certain aspects disclosed herein. In the embodiment depicted in FIG. 10, cloud infrastructure system 1002 may provide one or more cloud services that may be requested by users using one or more client computing devices 1004, 1006, and 1008. Cloud infrastructure system 1002 may comprise one or more computers and/or servers that may include those described above for server 912. The computers in cloud infrastructure system 1002 may be organized as general purpose computers, specialized server computers, server farms, server clusters, or any other appropriate arrangement and/or combination.

Network(s) 1010 may facilitate communication and exchange of data between clients 1004, 1006, and 1008 and cloud infrastructure system 1002. Network(s) 1010 may include one or more networks. The networks may be of the same or different types. Network(s) 1010 may support one or more communication protocols, including wired and/or wireless protocols, for facilitating the communications.

The embodiment depicted in FIG. 10 is only one example of a cloud infrastructure system and is not intended to be limiting. It should be appreciated that, in some other aspects, cloud infrastructure system 1002 may have more or fewer components than those depicted in FIG. 10, may combine two or more components, or may have a different configuration or arrangement of components. For example, although FIG. 10 depicts three client computing devices, any number of client computing devices may be supported in alternative aspects.

The term cloud service is generally used to refer to a service that is made available to users on demand and via a communication network such as the Internet by systems (e.g., cloud infrastructure system 1002) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1010 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1002 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1002 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1002. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1002. Cloud infrastructure system 1002 then performs processing to provide the services requested in the tenant's subscription order. Cloud infrastructure system 1002 may be configured to provide one or even multiple cloud services.

Cloud infrastructure system 1002 may provide the cloud services via different deployment models. In a public cloud model, cloud infrastructure system 1002 may be owned by a third party cloud services provider and the cloud services are offered to any general public tenant, where the tenant can be an individual or an enterprise. In certain other aspects, under a private cloud model, cloud infrastructure system 1002 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1002 and the services provided may be shared by several organizations in a related community. Various other models such as hybrids of the above mentioned models may also be used.

Client computing devices 1004, 1006, and 1008 may be of different types (such as devices 902, 904, 906, and 908 depicted in FIG. 9) and may be capable of operating one or more client applications. A user may use a client device to interact with cloud infrastructure system 1002, such as to request a service provided by cloud infrastructure system 1002.

In some aspects, the processing performed by cloud infrastructure system 1002 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1002 for determining the intent of an utterance. The data used for this analysis may include structured data (e.g., data stored in a database or structured according to a structured model) and/or unstructured data (e.g., data blobs (binary large objects)).

As depicted in the embodiment in FIG. 10, cloud infrastructure system 1002 may include infrastructure resources 1030 that are utilized for facilitating the provision of various cloud services offered by cloud infrastructure system 1002. Infrastructure resources 1030 may include, for example, processing resources, storage or memory resources, networking resources, and the like.

In certain aspects, to facilitate efficient provisioning of these resources for supporting the various cloud services provided by cloud infrastructure system 1002 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1002 may itself internally use services 1032 that are shared by different components of cloud infrastructure system 1002 and which facilitate the provisioning of services by cloud infrastructure system 1002. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1002 may comprise multiple subsystems. These subsystems may be implemented in software, or hardware, or combinations thereof. As depicted in FIG. 10, the subsystems may include a user interface subsystem 1012 that enables users of cloud infrastructure system 1002 to interact with cloud infrastructure system 1002. User interface subsystem 1012 may include various different interfaces such as a web interface 1014, an online store interface 1016 where cloud services provided by cloud infrastructure system 1002 are advertised and are purchasable by a consumer, and other interfaces 1018. For example, a tenant may, using a client device, request (service request 1034) one or more services provided by cloud infrastructure system 1002 using one or more of interfaces 1014, 1016, and 1018. For example, a tenant may access the online store, browse cloud services offered by cloud infrastructure system 1002, and place a subscription order for one or more services offered by cloud infrastructure system 1002 that the tenant wishes to subscribe to. The service request may include information identifying the tenant and one or more services that the tenant desires to subscribe to.

In certain aspects, such as the embodiment depicted in FIG. 10, cloud infrastructure system 1002 may comprise an order management subsystem (OMS) 1020 that is configured to process the new order. As part of this processing, OMS 1020 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1020 may then invoke the order provisioning subsystem (OPS) 1024 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1024 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1002 may send a response or notification 1044 to the requesting tenant to indicate when the requested service is now ready for use. In some instances, information (e.g., a link) may be sent to the tenant that enables the tenant to start using and availing the benefits of the requested services.

Cloud infrastructure system 1002 may provide services to multiple tenants. For each tenant, cloud infrastructure system 1002 is responsible for managing information related to one or more subscription orders received from the tenant, maintaining tenant data related to the orders, and providing the requested services to the tenant or clients of the tenant. Cloud infrastructure system 1002 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1002 may provide services to multiple tenants in parallel. Cloud infrastructure system 1002 may store information for these tenants, including possibly proprietary information. In certain aspects, cloud infrastructure system 1002 comprises an identity management subsystem (IMS) 1028 that is configured to manage tenant's information and provide the separation of the managed information such that information related to one tenant is not accessible by another tenant. IMS 1028 may be configured to provide various security-related services such as identity services, such as information access management, authentication and authorization services, services for managing tenant identities and roles and related capabilities, and the like.

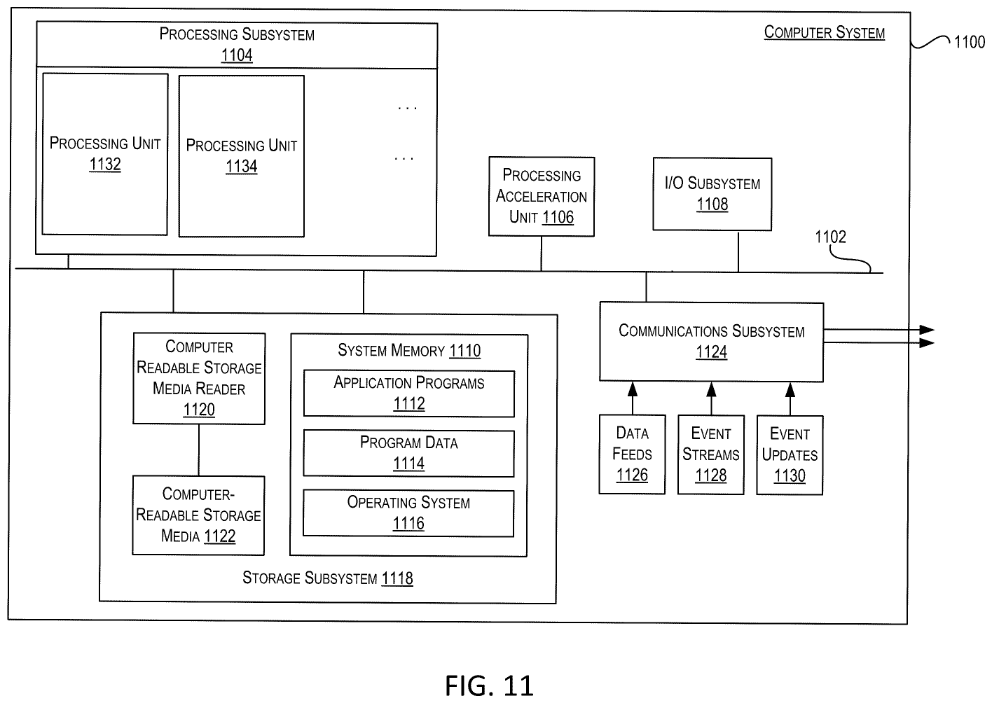

FIG. 11 illustrates an exemplary computer system 1100 that may be used to implement certain aspects. As shown in FIG. 11, computer system 1100 includes various subsystems including a processing subsystem 1104 that communicates with a number of other subsystems via a bus subsystem 1102. These other subsystems may include a processing acceleration unit 1106, an I/O subsystem 1108, a storage subsystem 1118, and a communications subsystem 1124. Storage subsystem 1118 may include non-transitory computer-readable storage media including storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative aspects of the bus subsystem may utilize multiple buses. Bus subsystem 1102 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1104 controls the operation of computer system 1100 and may comprise one or more processors, application specific integrated circuits (ASICs), or field programmable gate arrays (FPGAs). The processors may include be single core or multicore processors. The processing resources of computer system 1100 can be organized into one or more processing units 1132, 1134, etc. A processing unit may include one or more processors, one or more cores from the same or different processors, a combination of cores and processors, or other combinations of cores and processors. In some aspects, processing subsystem 1104 can include one or more special purpose co-processors such as graphics processors, digital signal processors (DSPs), or the like. In some aspects, some or all of the processing units of processing subsystem 1104 can be implemented using customized circuits, such as application specific integrated circuits (ASICs), or field programmable gate arrays (FPGAs).

In some aspects, the processing units in processing subsystem 1104 can execute instructions stored in system memory 1110 or on computer readable storage media 1122. In various aspects, the processing units can execute a variety of programs or code instructions and can maintain multiple concurrently executing programs or processes. At any given time, some or all of the program code to be executed can be resident in system memory 1110 and/or on computer-readable storage media 1122 including potentially on one or more storage devices. Through suitable programming, processing subsystem 1104 can provide various functionalities described above. In instances where computer system 1100 is executing one or more virtual machines, one or more processing units may be allocated to each virtual machine.

In certain aspects, a processing acceleration unit 1106 may optionally be provided for performing customized processing or for off-loading some of the processing performed by processing subsystem 1104 so as to accelerate the overall processing performed by computer system 1100.

I/O subsystem 1108 may include devices and mechanisms for inputting information to computer system 1100 and/or for outputting information from or via computer system 1100. In general, use of the term input device is intended to include all possible types of devices and mechanisms for inputting information to computer system 1100. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1100 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1118 provides a repository or data store for storing information and data that is used by computer system 1100. Storage subsystem 1118 provides a tangible non-transitory computer-readable storage medium for storing the basic programming and data constructs that provide the functionality of some aspects. Storage subsystem 1118 may store software (e.g., programs, code modules, instructions) that when executed by processing subsystem 1104 provides the functionality described above. The software may be executed by one or more processing units of processing subsystem 1104. Storage subsystem 1118 may also provide a repository for storing data used in accordance with the teachings of this disclosure.

Storage subsystem 1118 may include one or more non-transitory memory devices, including volatile and non-volatile memory devices. As shown in FIG. 11, storage subsystem 1118 includes a system memory 1110 and a computer-readable storage media 1122. System memory 1110 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1100, such as during start-up, may typically be stored in the ROM. The RAM typically contains data and/or program modules that are presently being operated and executed by processing subsystem 1104. In some implementations, system memory 1110 may include multiple different types of memory, such as static random access memory (SRAM), dynamic random access memory (DRAM), and the like.

By way of example, and not limitation, as depicted in FIG. 11, system memory 1110 may load application programs 1112 that are being executed, which may include various applications such as Web browsers, mid-tier applications, relational database management systems (RDBMS), etc., program data 1114, and an operating system 1116. By way of example, operating system 1116 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1122 may store programming and data constructs that provide the functionality of some aspects. Computer-readable media 1122 may provide storage of computer-readable instructions, data structures, program modules, and other data for computer system 1100. Software (programs, code modules, instructions) that, when executed by processing subsystem 1104 provides the functionality described above, may be stored in storage subsystem 1118. By way of example, computer-readable storage media 1122 may include non-volatile memory such as a hard disk drive, a magnetic disk drive, an optical disk drive such as a CD ROM, digital video disc (DVD), a Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1118 may also include a computer-readable storage media reader 1120 that can further be connected to computer-readable storage media 1122. Reader 1120 may receive and be configured to read data from a memory device such as a disk, a flash drive, etc.

In certain aspects, computer system 1100 may support virtualization technologies, including but not limited to virtualization of processing and memory resources. For example, computer system 1100 may provide support for executing one or more virtual machines. In certain aspects, computer system 1100 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1100. Accordingly, multiple operating systems may potentially be run concurrently by computer system 1100.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to establish a communication channel to one or more client devices via the Internet for receiving and sending information from and to the client devices.

Communication subsystem 1124 may support both wired and/or wireless communication protocols. For example, in certain aspects, communications subsystem 1124 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1124 can provide wired network connectivity (e.g., Ethernet) in addition to or instead of a wireless interface.

Communication subsystem 1124 can receive and transmit data in various forms. For example, in some aspects, in addition to other forms, communications subsystem 1124 may receive input communications in the form of structured and/or unstructured data feeds 1126, event streams 1128, event updates 1130, and the like. For example, communications subsystem 1124 may be configured to receive (or send) data feeds 1126 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1124 may be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to communicate data from computer system 1100 to other computer systems or networks. The data may be communicated in various different forms such as structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1100 depicted in FIG. 11 is intended only as a specific example. Many other configurations having more or fewer components than the system depicted in FIG. 11 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

1. A computer-implemented method comprising:
accessing a request for allocating graphical processing unit (GPU) resources for performing an operation, wherein the request includes metadata identifying a client identifier (ID) associated with a client, a throughput, and a latency of the operation;
determining a predicted resource limit for performing the operation based on the metadata;
obtaining at least one parameter of a plurality of GPU resources present in a plurality of nodes, wherein the at least one parameter comprises a status indicating whether a corresponding GPU resource is occupied for performing another operation;
determining a GPU resource utilization value of each node of the plurality of nodes based on the status of each GPU resource, wherein the GPU resource utilization value indicates an amount of utilization of GPU resources of corresponding node;
comparing the GPU resource utilization value of each node with a pre-defined resource utilization threshold value;
in response to determining that the GPU resource utilization value is less than the pre-defined resource utilization threshold value, re-scheduling the plurality of GPU resources based on the predicted resource limit; and
allocating a set of GPU resources from the plurality of re-scheduled GPU resources for performing the operation.

2. The method of claim 1, further comprising:
simulating the request on each node of the plurality of nodes;
determining a percentage of resource utilization for each node based on the simulation of the request;
identifying a node from the plurality of nodes having highest percentage of resource utilization; and
allocating the set of GPU resources from the identified node to the client.

3. The method of claim 1, further comprising:
determining a type of the operation based on the request; and
allocating the set of GPU resources from the plurality of GPU resources based on the type of the operation.

4. The method of claim 1, further comprising:
generating a dedicated AI cluster by patching the set of GPU resources within a single cluster, wherein the dedicated AI cluster reserves a portion of a computation capacity of a computing system for a period of time; and
allocating the dedicated AI cluster to the client associated with the client ID.

5. The method of claim 1, further comprising:
authenticating, prior to the allocation of the set of GPU resources, the request based on the client ID associated with the client, wherein the request is authenticated using a private key extracted from an asymmetric key pair associated with the client ID.

6. The method of claim 1, further comprising:
determining a number of tokens associated with the request;
determining whether the number of tokens exceeds a pre-defined request limit corresponding to the client ID; and
blocking the request based on the determination that the number of tokens exceeds the pre-defined request limit.

7. The method of claim 1, further comprising:
terminating patching of the set of GPU resources based on a pre-defined condition, wherein the pre-defined condition is one of:
a failure of the set of GPU resources during launch;
a workload failure of the set of GPU resources; and
a software bug detected in the set of GPU resources.

8. A system comprising:
one or more processors; and
a memory coupled to the one or more processors, the memory storing a plurality of instructions executable by the one or more processors, the plurality of instructions that when executed by the one or more processors cause the one or more processors to perform a set of operations comprising:
accessing a request for allocating graphical processing unit (GPU) resources for performing an operation, wherein the request includes metadata identifying a client identifier (ID) associated with a client, a throughput, and a latency of the operation;
determining a predicted resource limit for performing the operation based on the metadata;
obtaining at least one parameter of a plurality of GPU resources present in a plurality of nodes, wherein the at least one parameter comprises a status indicating whether a corresponding GPU resource is occupied for performing another operation;
determining a GPU resource utilization value of each node of the plurality of nodes based on the status of each GPU resource, wherein the GPU resource utilization value indicates an amount of utilization of GPU resources of corresponding node;
comparing the GPU resource utilization value of each node with a pre-defined resource utilization threshold value;
in response to determining that the GPU resource utilization value is less than the pre-defined resource utilization threshold value, re-scheduling the plurality of GPU resources based on the predicted resource limit; and
allocating a set of GPU resources from the plurality of re-scheduled GPU resources for performing the operation.

9. The system of claim 8, wherein the set of operations further includes:
simulating the request on each node of the plurality of nodes;
determining a percentage of resource utilization for each node based on the simulation of the request;
identifying a node from the plurality of nodes having highest percentage of resource utilization; and
allocating the set of GPU resources from the identified node to the client.

10. The system of claim 8, wherein the set of operations further includes:
determining a type of the operation based on the request; and
allocating the set of GPU resources from the plurality of GPU resources based on the type of the operation.

11. The system of claim 8, wherein the set of operations further includes:
generating a dedicated AI cluster by patching the set of GPU resources within a single cluster, wherein the dedicated AI cluster reserves a portion of a computation capacity of a computing system for a period of time; and
allocating the dedicated AI cluster to the client associated with the client ID.

12. The system of claim 8, wherein the set of operations further includes:
authenticating, prior to the allocation of the set of GPU resources, the request based on the client ID associated with the client, wherein the request is authenticated using a private key extracted from an asymmetric key pair associated with the client ID.

13. The system of claim 8, wherein the set of operations further includes:
determining a number of tokens associated with the request;
determining whether the number of tokens exceeds a pre-defined request limit corresponding to the client ID; and
blocking the request based on the determination that the number of tokens exceeds the pre-defined request limit.

14. The system of claim 8, wherein the set of operations further includes:
terminating patching of the set of GPU resources based on a pre-defined condition, wherein the pre-defined condition is one of:
a failure of the set of GPU resources during launch;
a workload failure of the set of GPU resources; and
a software bug detected in the set of GPU resources.

15. A non-transitory computer-readable medium storing a plurality of instructions executable by one or more processors that cause the one or more processors to perform a set of operations comprising:
accessing a request for allocating graphical processing unit (GPU) resources for performing an operation, wherein the request includes metadata identifying a client identifier (ID) associated with a client, a throughput, and a latency of the operation;
determining a predicted resource limit for performing the operation based on the metadata;
obtaining at least one parameter of a plurality of GPU resources present in a plurality of nodes, wherein the at least one parameter comprises a status indicating whether a corresponding GPU resource is occupied for performing another operation;
determining a GPU resource utilization value of each node of the plurality of nodes based on the status of each GPU resource, wherein the GPU resource utilization value indicates an amount of utilization of GPU resources of corresponding node;
comparing the GPU resource utilization value of each node with a pre-defined resource utilization threshold value;
in response to determining that the GPU resource utilization value is less than the pre-defined resource utilization threshold value, re-scheduling the plurality of GPU resources based on the predicted resource limit; and
allocating a set of GPU resources from the plurality of re-scheduled GPU resources for performing the operation.

16. The non-transitory computer-readable medium of claim 15, wherein the set of operations further comprises:
simulating the request on each node of the plurality of nodes;
determining a percentage of resource utilization for each node based on the simulation of the request;
identifying a node from the plurality of nodes having highest percentage of resource utilization; and
allocating the set of GPU resources from the identified node to the client.

17. The non-transitory computer-readable medium of claim 15, wherein the set of operations further comprises:
determining a type of the operation based on the request; and
allocating the set of GPU resources from the plurality of GPU resources based on the type of the operation.

18. The non-transitory computer-readable medium of claim 15, wherein the set of operations further comprises:
authenticating, prior to the allocation of the set of GPU resources, the request based on the client ID associated with the client, wherein the request is authenticated using a private key extracted from an asymmetric key pair associated with the client ID.

19. The non-transitory computer-readable medium of claim 15, wherein the set of operations further comprises:
determining a number of tokens associated with the request;
determining whether the number of tokens exceeds a pre-defined request limit corresponding to the client ID; and
blocking the request based on the determination that the number of tokens exceeds the pre-defined request limit.

20. The non-transitory computer-readable medium of claim 15, wherein the set of operations further comprises:
terminating patching of the set of GPU resources based on a pre-defined condition, wherein the pre-defined condition is one of:
a failure of the set of GPU resources during launch;
a workload failure of the set of GPU resources; and
a software bug detected in the set of GPU resources.
